(19) United States
(12) Patent Application Publication
(10) Pub. No.: US 2017/0098904 A1
(43) Pub. Date: Apr. 6, 2017

(54) MULTI-GROUND CONNECTOR FOR VEHICLE

(71) Applicants: HYUNDAI MOTOR COMPANY, Seoul (KR); KIA MOTORS CORPORATION, Seoul (KR); KUM CO., LTD., Ulsan (KR)

(72) Inventors: Mun Jong KIM, Suwon-si (KR); Min Kyu KIM, Suwon-si (KR); Sung Won JEON, Ulsan (KR); Dong Hoon LEE, Ulsan (KR)

(73) Assignees: HYUNDAI MOTOR COMPANY, Seoul (KR); KIA MOTORS CORPORATION, Seoul (KR); KUM CO., LTD., Ulsan (KR)

(21) Appl. No.: 15/218,168

(22) Filed: Jul. 25, 2016

(30) Foreign Application Priority Data
Oct. 6, 2015 (KR) 10-2015-0140599

(51) Int. Cl. H01R 13/14; H01R 13/73; H01R 13/52; H01R 13/502; H01R 13/516

(52) U.S. Cl. CPC H01R 13/14; H01R 13/502; H01R 13/516; H01R 13/521; H01R 13/73

(57) ABSTRACT

A multi-earth connector for a vehicle includes: a ground terminal to include a ground portion fixed to a vehicle body and pin terminals arranged in a plurality of rows; a socket terminal to include sockets inserted into the pin terminals and barrels to which an earth wiring is fixed; and a side holder coupled with the pin terminals and the sockets to inhibit a movement of the socket terminal.

### CROSS-REFERENCE TO RELATED APPLICATION

This application claims the benefit of Korean Patent Application No. 10-2015-0140599, filed on Oct. 6, 2015, which is incorporated herein by reference in its entirety.

### FIELD

The present disclosure relates to a multi-ground connector for a vehicle.

### BACKGROUND

The statements in this section merely provide background information related to the present disclosure and may not constitute prior art.

In general, various types of electric components (or devices) are installed in vehicles, and such electric components have mutually organic connection relations on the basis of an electronic control unit (ECU). Also, in order to standardize assembling and replacement, most electric components have connections with connectors inserted into output terminals and input terminals, and thus, most electric components have a plurality of installation connectors.

That is, various electric components such as a battery, an ignition device, a starting device, a charging device, a lighting device, a horn, a power window regulator, a wind shield wiper, various measuring instruments, and a cooling device and a heating device as air-conditioning devices are installed in vehicles and, in order for these electric components be electrically connected to a power source, electric wirings and terminals are required.

Various electronic equipment is configured to be operated upon receiving power from a battery and a power generator, and here, a positive (+) terminal is directly connected to an electric wire, while a grounded negative (−) terminal is connected to a vehicle body adjacent to an installation portion of an electronic component so as to be grounded. The reason why the negative (−) terminal of an electronic component is connected to an adjacent vehicle body is because the entirety of the vehicle body serves as a grounding point.

In vehicles, in order to connect various electric components to a battery, a vehicle body is used as a ground. For example, a positive electrode terminal of a battery is directly connected to electric components, but a negative electrode terminal is connected to electronic components in a manner of being grounded to a vehicle body. Here, even though the negative electrode terminal of the battery is grounded to a vehicle body, it has the same effect as that obtained when directly connected to an electronic component.

Recently manufactured vehicles include various types of electric components, and in order to simultaneously ground these electric components, a multi-ground terminal is used. A multi-ground terminal has a structure in which a plurality of ground terminals are stacked to be tightly attached and fixed using ground bolts.

### SUMMARY

An aspect of the present disclosure is to reduce a space required to be large as barrels are radially disposed when ground terminals are stacked. Also, another aspect of the present disclosure is to automate a manual manufacturing process to increase productivity. Also, another aspect of the present disclosure is to provide a multi-ground connector for a vehicle in which an electric wire connected to a barrel is not exposed.

According to one form of the present disclosure, a multi-ground connector for a vehicle includes: a ground terminal including a ground portion fixed to a vehicle body and pin terminals arranged in a plurality of rows; a socket terminal including sockets inserted into the pin terminals and barrels to which a ground wiring is fixed; and a side holder coupled in a direction perpendicular to a direction of the pin terminals and the sockets to inhibit a movement of the socket terminal.

The sockets may be formed in a plurality of rows so as to be inserted into the pin terminals, the sockets in the plurality of rows may include: first sockets in one row and second sockets in one row below the first sockets, wherein the second sockets are disposed between valleys of the first sockets.

The pin terminals may be arranged such that first terminals thereof are inserted into the first sockets and second terminals are staggered with respect to the first terminals so that the second terminals thereof are inserted into the second sockets.

The first sockets and the second sockets may each have an insertion recess into which the side holder is inserted.

An end portion of the first sockets and second sockets may form a protrusion that protrudes toward the interior of the first sockets and second sockets.

The side holder may have a plurality of guide portions to be inserted into the first sockets and the second sockets.

The plurality of guide portions may include a first guide inserted into an upper side of the first sockets, a second guide inserted into a lower side of the second sockets, and a third guide disposed between the first guide and the second guide and configured to penetrate through a space between the first sockets and the second sockets.

A stoppage hole may be formed at a front end of each of the pin terminals and coupled to the protrusion to inhibit a movement of the socket terminal.

The sockets may each have a U shape surrounding the pin terminals.

The multi-ground connector may further include a housing in which the ground terminal and the socket terminal are disposed therein, wherein the ground terminal may be disposed such that the ground portion and the ground wiring protrude outwardly from the housing.

The housing may have a guide recess configured to allow the side holder to be inserted therein, and the side holder may be inserted into the guide recess and the insertion recess.

A coupling hole to be caught by the housing may be formed in each of the first guide and the second guide.

The housing may include: a first housing configured to have an accommodation space in which the ground terminal and the sockets are disposed; and a second housing coupled to the top of the first housing, wherein a waterproof pad configured to protect the ground terminal and the sockets may be disposed in the accommodation space.

A plurality of waterproof pads may be provided, and the pin terminals may be disposed between the plurality of waterproof pads.

A mounting recess on which the waterproof pad is disposed may be formed in the accommodation space, and the pin terminals may be disposed on the waterproof pad disposed on the mounting recess.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view illustrating a multi-ground connector for a vehicle;

FIG. 2 is a plan view of FIG. 1;

FIG. 3 is a front view of FIG. 2;

FIG. 4 is a perspective view illustrating a multi-ground connector and a side holder;

FIG. 5 is an exploded perspective view of FIG. 1;

FIG. 6 is a cross-sectional view taken along line A-A of FIG. 2;

FIG. 7 is a cross-sectional view taken along line B-B of FIG. 2; and

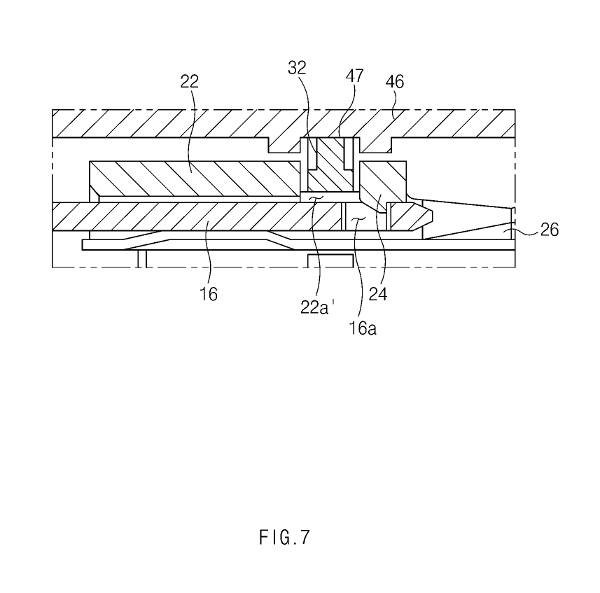

FIG. 8 is a side view illustrating a socket terminal in which a pin terminal of FIG. 7 is inserted.

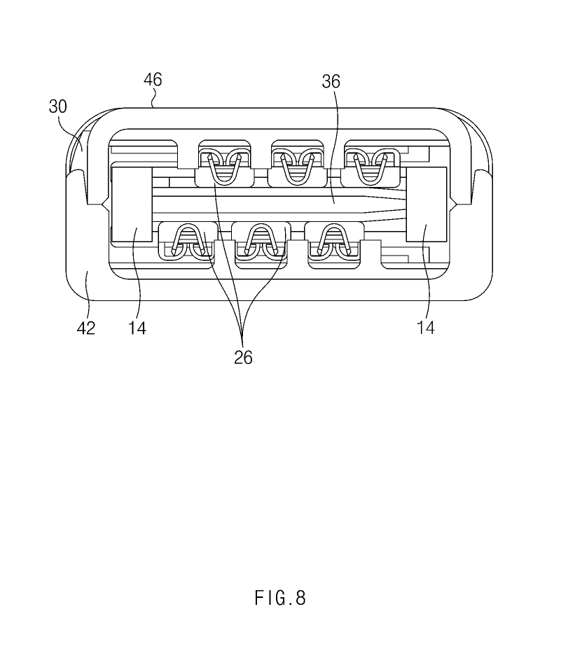

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

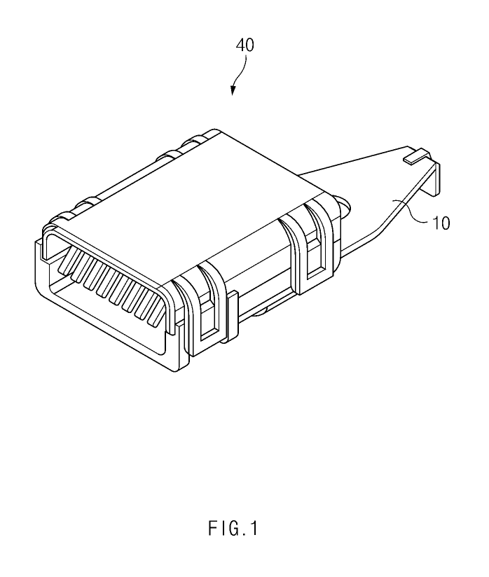

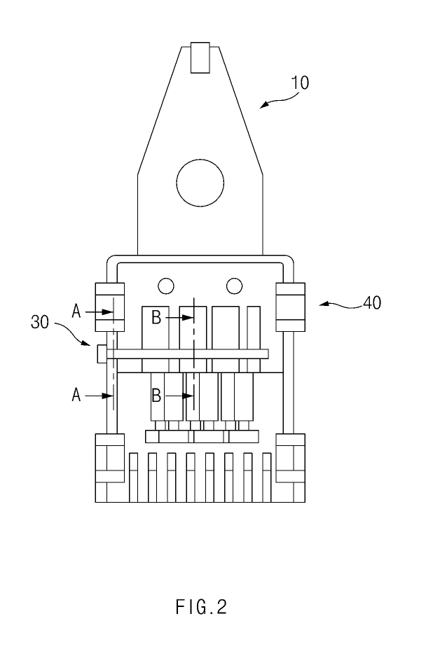

Referring to FIGS. 1 through 5, the multi-ground connector for a vehicle according to one form of the present disclosure includes: a ground portion fixed to a vehicle body; a ground terminal 10 in which pin terminals are arranged in a plurality of rows; a socket terminal 20 including sockets 22 inserted into the pin terminals 16 and barrels 26 to which ground wirings are fixed; and a side holder 30 coupled in a direction perpendicular to a direction of the pin terminal 16 and the socket 20 to inhibit a movement of the socket terminal 20.

The ground terminal 10 includes a ground portion 12 fixed to a vehicle body and the pin terminals 16 arranged in a plurality of rows. In the ground terminal 10, the pin terminals 16 arranged in a plurality of rows are formed in an extending portion 14 extending from the ground portion 12 fixed to a vehicle body. The ground portion 12 may have a through hole to be fixed to the vehicle body.

The pin terminals 16 are provided to be arranged in a plurality rows in the extending portion 14. The pin terminals 16 are formed in two upper and lower rows. Stoppage holes 16a are formed at front ends of the pin terminals 16 and coupled to protrusions 22a provided to inhibit a movement of the socket terminal 20. The pin terminals 16 include first terminals in an upper one row and second terminals in a lower one row, and the first terminals and the second terminals are provided to be staggered.

In the socket terminal 20, the sockets 22 inserted into the pin terminals 16 and the barrels 26 to which a ground wiring is fixed are formed. The sockets 22 are formed in a plurality of rows. The sockets 22 in the plurality of rows include first sockets 22a in an upper one row and second sockets 22b in a lower one row. In the sockets 22, the second sockets may be disposed between valleys of the first sockets 22a. In the sockets 22, the first sockets 22a and the second sockets 22b are staggered with each other. The first terminals are inserted into the first sockets 22a, and the second terminals are inserted into the second sockets 22b.

The first sockets 22a and the second sockets 22b may have insertion recesses into which the side holder 30 is inserted. In one form, an insertion recess 22a′ is formed in the first socket 22a. A protrusion 24 protruding inwardly may be formed in an end portion of each of the first sockets 22a.

A protrusion 24 protruding inwardly may be formed in an end portion of each of the second sockets 22b, like the first sockets 22a. The socket 22 may have a U shape surrounding the pin terminal 16. The barrel 26 may include a first barrel 26a extending from the first socket 22a and a second barrel 26b extending from the second socket 22b.

The side holder 30 is coupled in a direction perpendicular to the direction of the pin terminal 16 and the socket 22 in order to inhibit a movement of the socket terminal 20. The side holder 30 may have a plurality of guide portions 32, 34, and 36 to be inserted into to first socket 22a and the second socket 22b. The side holder 30 may have a handle portion 30a to be pushed into the housing 40. In the side holder 30, the guide portions 32, 34, and 36 extend from the handle portion 30a.

The guide portions 32, 34, and 36 may include a first guide 32 inserted in an upper side of the first socket 22a, a second guide 34 inserted into a lower side of the second socket 22b, and a third guide 36 formed between the first guide 32 and the second guide 34 and penetrating through a space between the first socket 22a and the second socket 22b.

Coupling holes 32a and 34a caught by the housing 40 may be formed in the first guide 32 and the second guide 34, respectively. The coupling holes 32a and 34a may include a first coupling hole 32a formed in the first guide 32 and a second coupling hole 34a formed in the second guide 34. The first coupling hole 32a and the second coupling hole 34a are caught in insertion recesses of the housing 40 to inhibit the side holder 30 from being excessively entering guide recesses 43 and 47 or released therefrom.

The housing 400 is provided to cover the ground terminal 10 and the socket terminal 20. The housing 40 forms an outer appearance such that the ground terminal 10 and the socket terminal 2 are disposed therein. In the housing 40, the ground portion 12 of the ground terminal 10 protrudes outwardly from the housing 40 and fixed to a vehicle or connected to a ground wiring.

The housing 40 has guide recesses 43 and 47 into which the side holder 30 is inserted. The housing has a first housing 42 having an accommodation space in which the ground terminal 10 and the socket 20 are disposed.

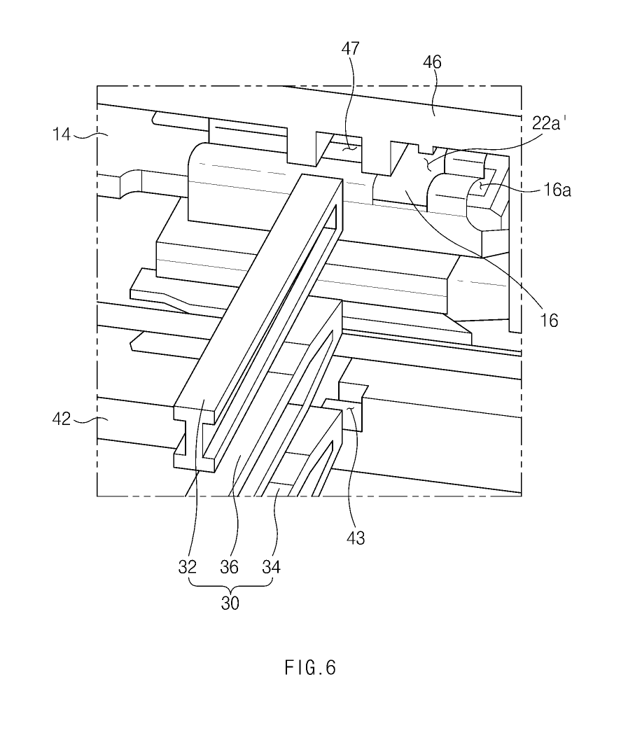

In the housing 40, a second housing 46 is coupled to the top of the first housing 42 to cover the accommodation space. Here, in the housing 40, the accommodation space formed in the first housing 42 and the accommodation space formed in the second housing 46 are the same, and thus, the first housing 42 will be described as an example. Referring to FIG. 6, the guide recess formed in the first housing 42 of the housing 40 will be described as an example. The guide recess 43 and the insertion recess 22a′ may be disposed to be perpendicular with respect to each other such that the side holder 30 is inserted therein.

The ground terminal 10 and the socket 20 are coupled and disposed in the accommodation space of the first housing 42. A waterproof pad 52 may be disposed in the accommodation space of the first housing 42 in order to protect the ground terminal 10 and the socket 20. A mounting recess 42a on which the waterproof pad 52 is disposed is formed in the accommodation space.

The pin terminals 16 may be disposed above the waterproof pad 52 disposed on the mounting recess 42a. The first housing 42 may have hook portions 42b to be coupled to the second housing 46. Hook stoppage portions 46b may be formed in the second housing 46 such that the hook stoppage portions 46b are caught by the hook portions 42b. The hook portions 42b and the hook stoppage portions 46b are formed on outer circumferential surfaces of the first housing 42 and the second housing 46, respectively.

A plurality of waterproof pads 52 and 54 may be disposed above and below the pin terminals 16 so as to be fixed to the housing 40. The waterproof pads 52 and 64 may include a first pad 52 disposed below the pin terminals 16 and a second pad 54 disposed above the pin terminals 16.

An operation of the multi-ground connector for a vehicle will be described.

Referring to FIGS. 1 through 5, the ground terminal 10 and the socket terminal 20 are coupled. The sockets 22 are inserted into the pin terminals 16. Here, the protrusions 22a of the sockets 22 are insertedly coupled to the stoppage holes 16a of the pin terminals 16. Thus, the socket terminal 20 is inhibited from being released from the ground terminal 10, reducing arc generation.

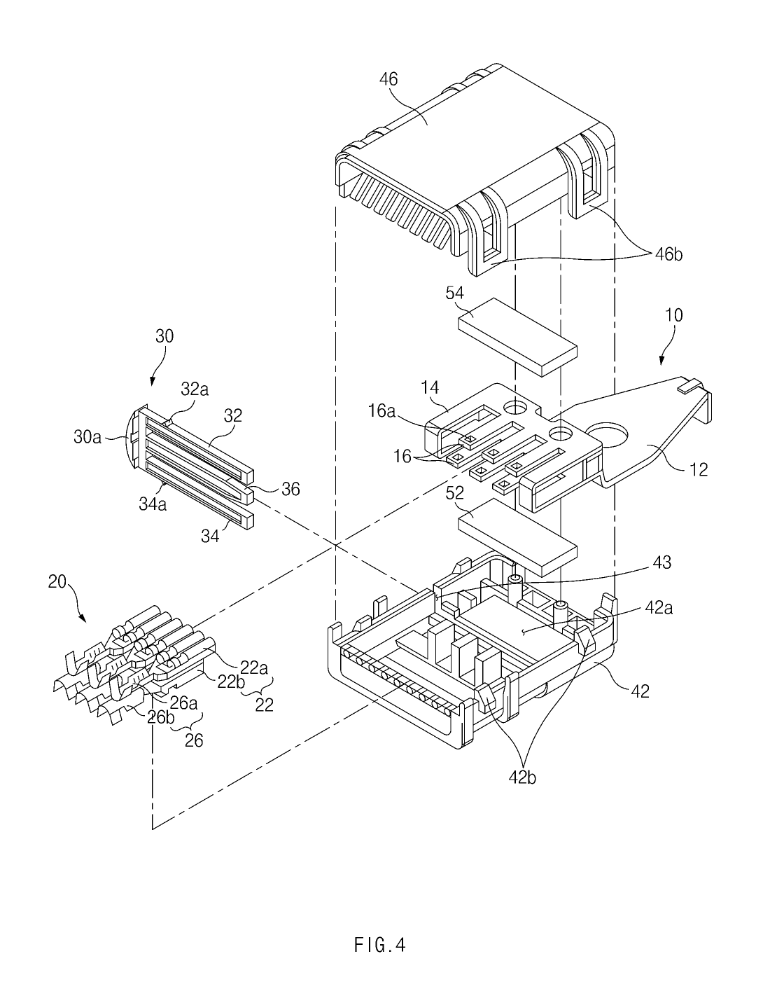

The ground portion 12 of the ground terminal 10 may be disposed to protrude partially to the outside of the housing 20 and fixed and grounded to a vehicle. Here, the waterproof pads 52 and 54 are disposed with the pin terminals 16 mounted on the mounting recess 42a of the housing 40 interposed therebewteen. The ground terminal 10 and the ground portion 12 are disposed between the first housing 42 and the second housing 46, and the first housing 42 and the second housing 46 are coupled by inserting the hook stoppage portions 46b to the hook portions 42b. As illustrated in FIG. 4, the side holder 30 is inserted in a direction perpendicular to the socket terminal 20 disposed in the housing 40

Referring to FIG. 6, the side holder 30 is inserted into the interior of the housing 40 along the guide recesses 43 and 47 through insertion recesses of the housing 40. Here, the first guide portion 32 of the side holder 30 is moved along the guide recess 47 of the second housing 46 and also moved along the insertion recess 22a′ of the first socket 22a.

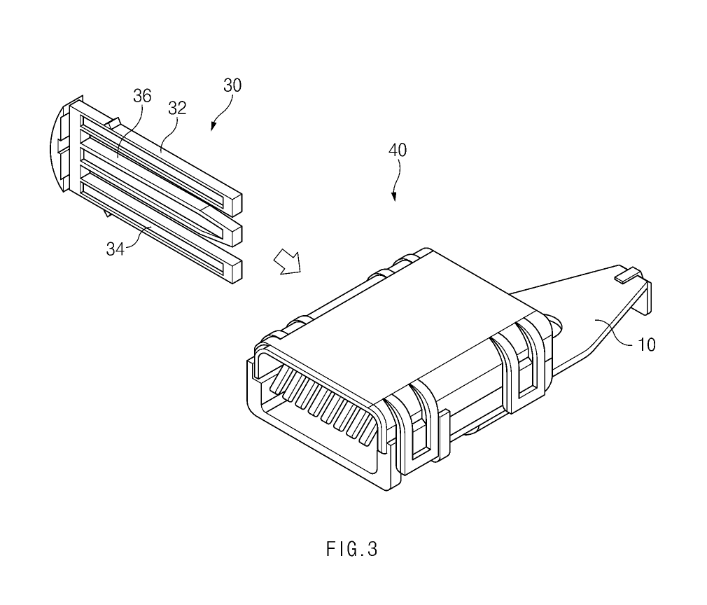

The second guide portion 34 of the side holder 30 is moved along the guide recess 43 of the first housing 42 and also moved along the insertion recess of the second socket 22b. Referring to FIG. 3, the third guide portion 36 penetrates through a space between the first socket 22a and the second socket 22b.

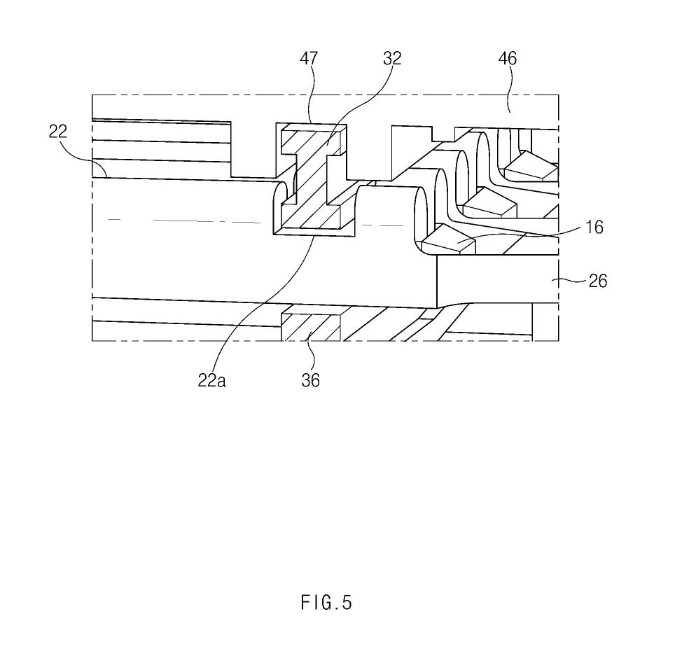

Referring back to FIGS. 4 and 5, the socket terminal 20 is fixed by the protrusion 24 of the socket 22 and the stoppage hole 16a of the ground terminal 10. Thereafter, the side holder 30 is inserted into the housing 40 to fix the socket terminal 20 and the ground terminal 10 and simultaneously inhibit a movement of the socket terminal 20 and the ground terminal 10 coupled in the housing 40.

Also, the coupling holes 32a and 34a of the first guide portion 32 and the second guide portion 34 of the side holder 30 are caught in the housing 40 to inhibit excessive entering and releasing of the side holder 30, thus firmly supporting the socket 20 and the ground terminal 10.

According to the multi-ground connector for a vehicle according to the present disclosure, the plurality of pin terminals may be provided and arranged in a plurality of rows, reducing a volume of the connector and increasing the number of connectable terminals. Also, since the socket terminals and the pin terminal are coupled to inhibit a movement of the socket terminal, and when the socket terminal and the pin terminals are coupled and the side holder is installed, a movement of the socket terminal is further inhibited. Also, since the side holder is inserted from outside of the housing, a coupling rate of the socket terminal and the pin terminals is enhanced, and whether the socket terminal and the pin terminals are fastened may be known through coupling of the side holder. Also, since the socket terminal and the pin terminals are provided within the housing, aesthetic appearance and stability may be enhanced.

As described above, the multi-ground connector for a vehicle according to one form of the present disclosure may have the following advantages.

First, since the plurality of pin terminals are provided and arranged in a plurality of rows, a volume of the connector may be reduced and the number of connectable terminals may be increased.

Second, since the socket terminals and the pin terminal are coupled, a movement of the socket terminal may be inhibited

Third, when the socket terminal and the pin terminals are coupled and the side holder is installed, a movement of the socket terminal is further inhibited.

Fourth, since the side holder is inserted from outside of the housing, a coupling rate of the socket terminal and the pin terminals is enhanced, and whether the socket terminal and the pin terminals are fastened may be known through coupling of the side holder.

Fifth, since the socket terminal and the pin terminals are provided within the housing, aesthetic appearance and stability may be enhanced.

Sixth, manually manufactured components may be manufactured through an automation process, reducing manufacturing cost and a defect generation rate.

Technical effects of the present disclosure are not limited to the foregoing technical effects and any other technical effects not mentioned will be understood from the following descriptions and become apparent by exemplary forms of the present disclosure.

The configuration and method of the multi-ground connector for a vehicle according to the exemplary forms of the present disclosure described above are not limited in its application, but the exemplary forms may be selectively combined to be configured into various modifications.

The present disclosure may be variously modified and altered by those skilled in the art to which the present disclosure pertains without departing from the spirit and scope of the present disclosure claimed in the following claims.

What is claimed is:

1. A multi-ground connector for a vehicle, the multi-ground connector comprising:
a ground terminal including a ground portion fixed to a vehicle body and pin terminals arranged in a plurality of rows;
a socket terminal including sockets inserted into the pin terminals and barrels to which a ground wiring is fixed; and
a side holder coupled with the pin terminals and the sockets to inhibit a movement of the socket terminal.

2. The multi-ground connector according to claim 1, wherein the sockets are formed in a plurality of rows so as to receive the pin terminals, and wherein the sockets comprises:
first sockets in one row; and
second sockets in one row below the first sockets, wherein the second sockets are disposed between valleys of the first sockets.

3. The multi-ground connector according to claim 2, wherein the pin terminals are arranged such that first terminals thereof are inserted into the first sockets and second terminals are staggered with respect to the first terminals so that the second terminals are inserted into the second sockets.

4. The multi-ground connector according to claim 2, wherein the first sockets and the second sockets each have an insertion recess into which the side holder is inserted.

5. The multi-ground connector according to claim 4, wherein an end portion of the first sockets and second sockets forms a protrusion which protrudes toward an interior of the first and second sockets.

6. The multi-ground connector according to claim 2, wherein the side holder includes a plurality of guide portions configured to be inserted into the first sockets and the second sockets.

7. The multi-ground connector according to claim 6, wherein the plurality of guide portions include:
a first guide inserted into an upper side of the first sockets;
a second guide inserted into a lower side of the second sockets; and
a third guide disposed between the first guide and the second guide and configured to penetrate through a space between the first sockets and the second sockets.

8. The multi-ground connector according to claim 5, wherein a stoppage hole is formed at a front end of each of the pin terminals and is coupled to the protrusion to inhibit a movement of the socket terminal.

9. The multi-ground connector according to claim 1, wherein the sockets each have a U shape surrounding the pin terminals.

10. The multi-ground connector according to claim 1, further comprising a housing in which the ground terminal and the socket terminal are disposed therein,
wherein the ground terminal is disposed such that the ground portion and the ground wiring protrude outwardly from the housing.

11. The multi-ground connector according to claim 10, wherein the housing comprises a guide recess configured to allow the side holder to be inserted therein, and the side holder is inserted into the guide recess and an insertion recess.

12. The multi-ground connector according to claim 11, wherein a coupling hole to be caught by the housing is formed in each of a first guide and a second guide.

13. The multi-ground connector according to claim 10, wherein the housing includes:
a first housing configured to have an accommodation space in which the ground terminal and the sockets are disposed; and
a second housing coupled to a top of the first housing,
wherein a waterproof pad configured to protect the ground terminal and the sockets is disposed in the accommodation space.

14. The multi-ground connector according to claim 13, wherein a plurality of waterproof pads are provided, and
the pin terminals are disposed between the plurality of waterproof pads.

15. The multi-ground connector according to claim 13, wherein a mounting recess on which the waterproof pad is disposed is formed in the accommodation space, and
the pin terminals are disposed on the waterproof pad disposed on the mounting recess.

16. A multi-ground connector for a vehicle, comprising:
a ground terminal including a ground portion fixed to a vehicle body and pin terminals arranged in a plurality of rows;
a socket terminal including first sockets and second sockets inserted into the pin terminals and barrels to which a ground wiring is fixed; and
a side holder coupled with the pin terminals and the sockets to traverse the sockets and the pin terminals to inhibit a movement of the socket terminal.

17. The multi-ground connector according to claim 16, further comprising a housing in which the ground terminal and the socket terminal are disposed therein,
wherein an insertion recess configured to allow the side holder to be inserted therein is formed in each of the first sockets and the second sockets, and
the housing has a guide recess configured to allow the side holder to be inserted therein, and the side holder is inserted into the insertion recess and the guide recess.
